(19) United States
(12) Patent Application Publication
(10) Pub. No.: US 2014/0372903 A1
(43) Pub. Date: Dec. 18, 2014

(54) Independent Hit Testing for Touchpad Manipulations and Double-Tap Zooming

(71) Applicant: Microsoft Corporation, Redmond, WA (US)

(72) Inventors: Matthew Allen Rakow, Seattle, WA (US); Krishnan Menon, Redmond, WA (US); Michael J. Ens, Redmond, WA (US); Jonathan Wills, Bothell, WA (US)

(21) Appl. No.: 13/918,547

(22) Filed: Jun. 14, 2013

(51) Int. Cl. G06F 3/0481; G06F 3/0488

(52) U.S. Cl. CPC G06F 3/0481; G06F 3/04883
USPC 715/752

(57) ABSTRACT

In one or more embodiments, a hit test thread which is separate from the main thread, e.g. the user interface thread, is utilized for hit testing on web content. Using a separate thread for hit testing can allow targets to be quickly ascertained. In cases where the appropriate response is handled by a separate thread, such as a manipulation thread that can be used for touch manipulations such as panning and pinch zooming, manipulation can occur without blocking on the main thread. This results in the response time that is consistently quick even on low-end hardware over a variety of scenarios.

### BACKGROUND

Hit testing refers to a process that determines content that is located at a given set of coordinates in web content, such as a webpage. A common scenario for hit testing pertains to that which involves user input, e.g., receiving touch input or mouse click input. Specifically, in order to determine a correct response to user input, hit testing is performed to discover which content is the subject of the user's interaction. Anything that delays a hit test can, in turn, delay the system's response and degrade the user's experience.

In many systems, hit testing is performed on a main thread, for example, the user interface thread. The user interface thread can, however, frequently be busy performing other work. This other work can include JavaScript execution, layout tasks, rendering operations, and the like. As a result, hit tests that occur on the main thread may be blocked for prolonged and variable periods of time.

### SUMMARY

This Summary is provided to introduce a selection of concepts in a simplified form that are further described below in the Detailed Description. This Summary is not intended to identify key features or essential features of the claimed subject matter.

In one or more embodiments, a hit test thread which is separate from the main thread, e.g. the user interface thread, is utilized for hit testing on web content. Using a separate thread for hit testing can allow targets to be quickly ascertained. In cases where the appropriate response is handled by a separate thread, such as a manipulation thread that can be used for touch manipulations such as panning and pinch zooming, manipulation can occur without blocking on the main thread. This results in a response time that is consistently quick even on low-end hardware over a variety of scenarios.

In at least some embodiments, a mechanism is provided for web developers to request specific default behaviors, such as touch behaviors, on their webpages. In at least some implementations, a Cascading Style Sheets (CSS) rule is utilized to enable or disable manipulations such as panning, pinch zoom, and double-tap-zoom manipulations. The mechanism can be extensible to accommodate additional default behaviors that are added in the future. In various embodiments, the behaviors are declared up front and thus differ from solutions which employ an imperative model. The declarative nature of this approach allows achievement of full independence from the main thread in deciding the correct response using independent hit testing.

Some embodiments provide an ability to perform additional processing and/or logic handling within an independent hit test thread. In some cases, the independent hit test thread can be configured to identify between one or more input scenarios. Alternately or additionally, one or more response actions to the input scenarios can be at least partially initialized. Upon determining a distinct input scenario from one or more input scenarios, an associated response action can be initiated and/or passed to a separate thread for execution. At times, a notification to terminate a response action can be sent to threads managing partially initialized response actions.

### BRIEF DESCRIPTION OF THE DRAWINGS

The detailed description references the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform the various embodiments described herein.

FIG. 2 is a sequence diagram in accordance with one or more embodiments.

FIG. 3 is a flow diagram that describes steps in a method in accordance with one or more embodiments.

FIG. 3a is a flow diagram that describes steps in a method in accordance with one or more embodiments.

FIG. 3b is a flow diagram that describes steps in a method in accordance with one or more embodiments.

FIG. 4 is a sequence diagram in accordance with one or more embodiments.

FIG. 5 is a sequence diagram in accordance with one or more embodiments.

FIG. 6 is a flow diagram that describes steps in a method in accordance with one or more embodiments.

FIG. 7 illustrates an example system that includes the computing device as described with reference to FIG. 1.

FIG. 8 illustrates various components of an example device that can be implemented as any type of computing device as described herein.

### DETAILED DESCRIPTION

Overview

In one or more embodiments, a hit test thread which is separate from the main thread, e.g. the user interface thread, is utilized for hit testing on web content, here termed “independent hit testing”. Using a separate thread for hit testing can allow targets to be quickly ascertained. In cases where the appropriate response is handled by a separate thread, such as a manipulation thread that can be used for touch manipulations such as panning and pinch zooming, manipulation can occur without blocking on the main thread. This results in a response time that is consistently quick even on low-end hardware over a variety of scenarios.

In at least some embodiments, a scoped display tree traversal can be performed during this hit test. This can, in some instances, avoid a full tree traversal to determine an appropriate response. As a result, performance can be improved by skipping irrelevant portions of the display tree.

Further, at least some embodiments enable an ability to designate specific regions of a single display tree node which are to be considered during independent hit testing. This can be used, for example, in cases where a single display tree node has sub-regions of interest that will change the decision about the appropriate response. Such regions of interest can include, by way of example and not limitation, a playback slider on a video element or the resize grippers on editable content.

In yet other embodiments, an application can register a callback handler which will be executed as part of the response to the hit test. This can be used for additional, host-specific actions which go beyond the typical built-in functionality.

In at least some embodiments, a mechanism is provided for web developers to request specific default behaviors, such as touch behaviors, on their webpages. In at least some implementations, a Cascading Style Sheets (CSS) rule is utilized to enable or disable manipulations such as panning, pinch zoom, and double-tap-zoom manipulations. The mechanism can be extensible to accommodate additional default behaviors that are added in the future. In various embodiments, the behaviors are declared up front and thus differ from solutions which employ an imperative model. The declarative nature of this approach allows achievement of full independence from the main thread in deciding the correct response using independent hit testing.

Use of the CSS rule can facilitate application of requested specific default behaviors to many separate regions on a webpage. This can be as simple as setting a CSS class on each region to be configured.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

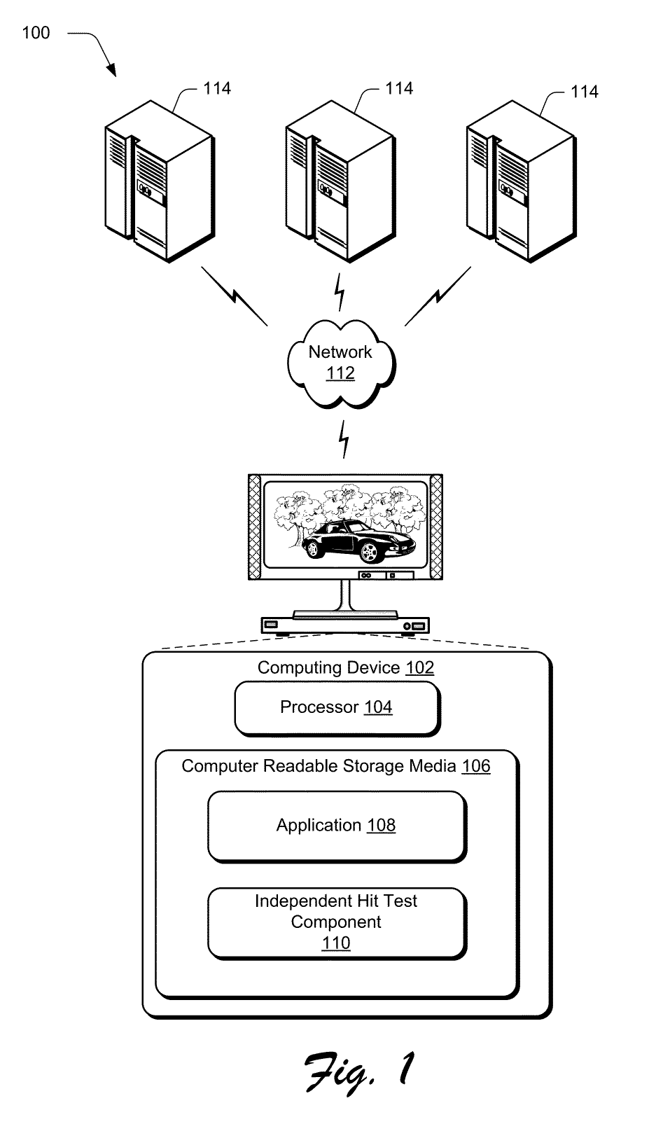

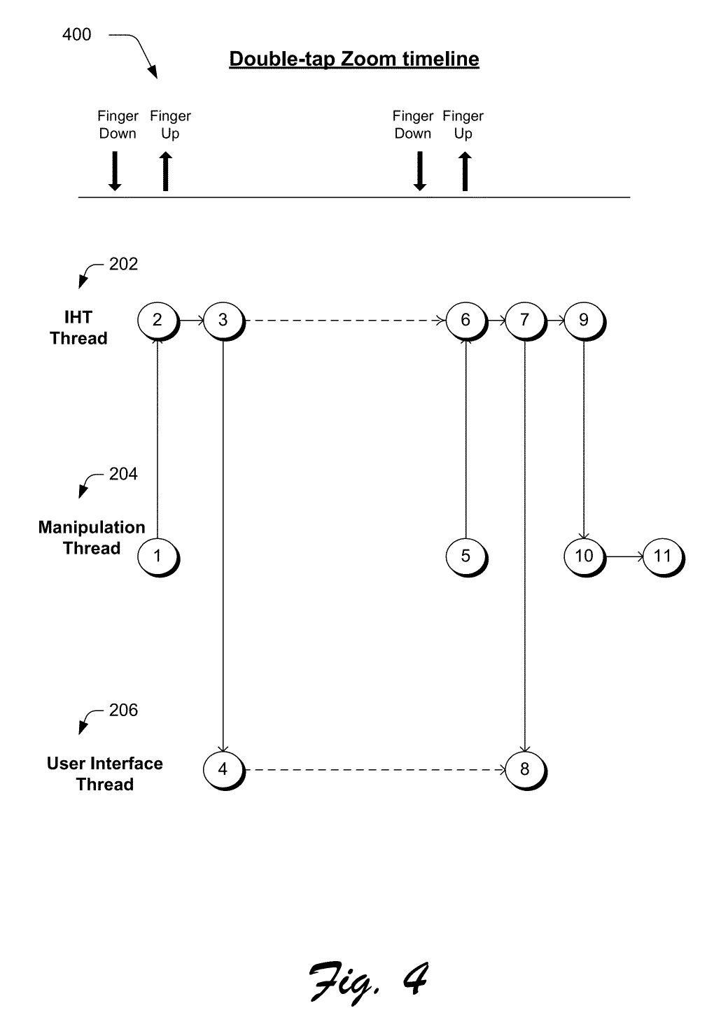

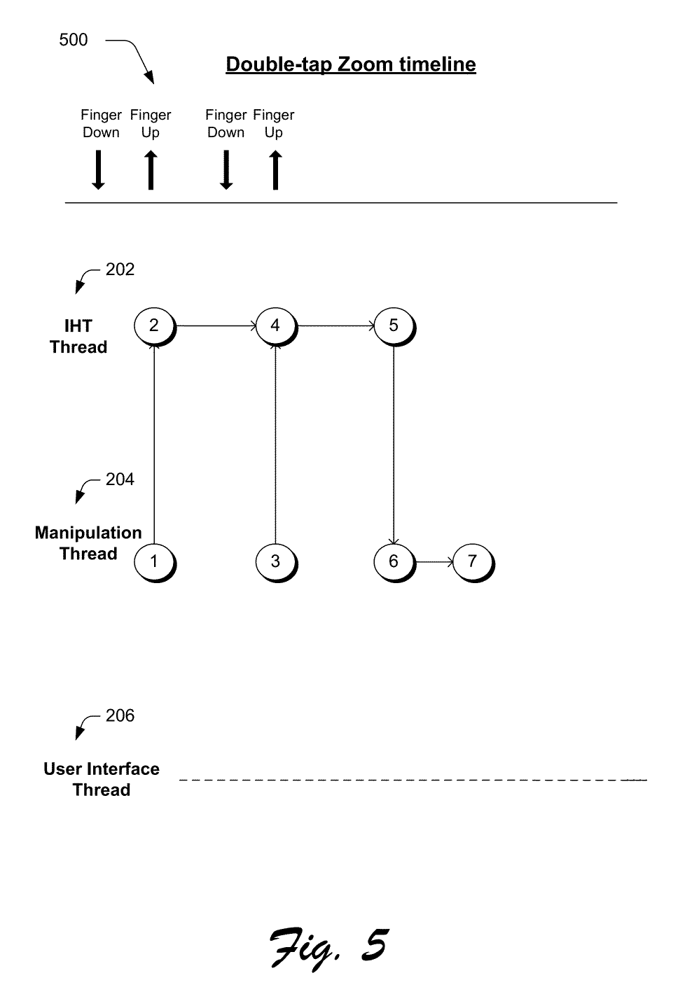

FIG. 1 illustrates an operating environment in accordance with one or more embodiments, generally at 100. Environment 100 includes a computing device 102 in the form of a local client machine having one or more processors 104, one or more computer-readable storage media 106, one or more applications 108 that resides on the computer-readable storage media and which are executable by the processor 104. Computing device 102 also includes an independent hit test component 110 that operates as described below. Computing device 102 can be embodied as any suitable computing device such as, by way of example and not limitation, a desktop computer, a portable computer, a handheld computer such as a personal digital assistant (PDA), mobile phone, television, tablet computer, and the like. Varieties of different examples of a computing device 102 are shown and described below in FIGS. 4 and 5.

Applications 108 can include any suitable type of applications including, by way of example and not limitation, a web browser and/or various other web applications. The web browser is configured to navigate via the network 112. Although the network 112 is illustrated as the Internet, the network may assume a wide variety of configurations. For example, the network 112 may include a wide area network (WAN), a local area network (LAN), a wireless network, a public telephone network, an intranet, and so on. Further, although a single network 112 is shown, the network 112 may be configured to include multiple networks.

The browser, for instance, may be configured to navigate via the network 112 to interact with content available from one or more web servers 114 as well as communicate data to the one or more web servers 114, e.g., perform downloads and uploads. The web servers 114 may be configured to provide one or more services that are accessible via the network 112. Examples of such services include email, web pages, photo sharing sites, social networks, content sharing services, media streaming services, and so on.

One or more of the applications 108 may also be configured to access the network 112, e.g., directly themselves and/or through the browser (in the event an application 108 is not a web browser). For example, one or more of the applications 108 may be configured to communicate messages, such as email, instant messages, and so on. In additional examples, an application 108, for instance, may be configured to access a social network, obtain weather updates, interact with a bookstore service implemented by one or more of the web servers 114, support word processing, provide spreadsheet functionality, support creation and output of presentations, and so on.

Thus, applications 108 may also be configured for a variety of functionality that may involve direct or indirect network 112 access. For instance, the applications 108 may include configuration settings and other data that may be leveraged locally by the application 108 as well as synchronized with applications that are executed on another computing device. In this way, these settings may be shared by the devices. A variety of other instances are also contemplated. Thus, the computing device 102 may interact with content in a variety of ways from a variety of different sources. In addition, the applications can work in offline scenarios as well, e.g., browsing through content from a USB device.

In operation, independent hit test component 110 provides a hit test thread which is separate from a main thread, e.g. the user interface thread. The independent hit test thread is utilized for hit testing on web content that mitigates the effects of hit testing on the main thread. Using a separate thread for hit testing can allow targets to be quickly ascertained. In cases where the appropriate response is handled by a separate thread, such as a manipulation thread that can be used for touch manipulations such as panning and pinch zooming, manipulation can occur without blocking on the main thread. This results in a response time that is consistently quick even on low-end hardware over a variety of scenarios. Alternately or additionally, independent hit test component 110 can be configured to identify one or more input scenarios and/or notify alternate thread(s) of the input scenarios effective to perform at least partial initialization of associated response action(s) via the alternate threads.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 102 may also include an entity (e.g., software) that causes hardware or virtual machines of the computing device 102 to perform operations, e.g., processors, functional blocks, and so on. For example, the computing device 102 may include a computer-readable medium that may be configured to maintain instructions that cause the computing device, and more particularly the operating system and associated hardware of the computing device 102 to perform operations. Thus, the instructions function to configure the operating system and associated hardware to perform the operations and in this way result in transformation of the operating system and associated hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Having described an example environment in which the techniques described herein may operate, consider now a discussion of some example embodiments that can utilize the principles described herein.

### Example Embodiments

In the discussion below, the following terminology is used. The concepts of dependent and independent regions are introduced.

A “dependent region” is a region of web content that utilizes the main thread, i.e., the user interface thread, for hit testing. Dependent regions can be associated with input or “hits” that occur over a control such as <input type=“range”> where the interaction with the page does not trigger a manipulation. Other dependent regions can include, by way of example and not limitation, those associated with selection handlers, adorners, scrollbars, and controls for video and audio content. Such dependent regions can also include, by way of example and not limitation, windowless ActiveX controls, where the intent of third-party code is not known.

An “independent region” is a region of web content that does not have to utilize the main thread for hit testing. Independent regions typically include those regions that are normally panned or zoomed by a user.

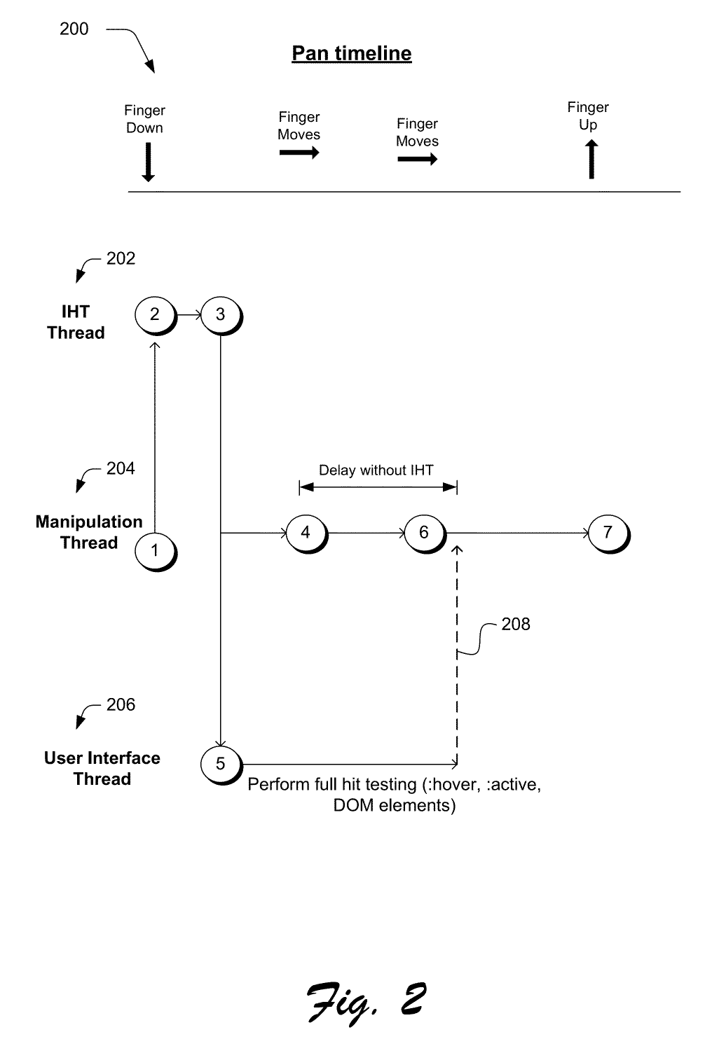

FIG. 2 illustrates an example sequence diagram, generally at 200, associated with a pan manipulation in which a user executes a gesture in the form of a “pointer down” gesture with a subsequent slide to pan content. Any suitable type of input can be provided for the pointer down gesture. For example, in the illustrated example the pointer down gesture is executed by the user touch-engaging content displayed on a display screen and moving their finger to execute a pan. Other types of input can be received from, by way of example and not limitation, input devices such as a mouse input, a stylus input, natural user interface (NUI) input and the like. In addition, other manipulations can be processed as described just below. Such other manipulations can include, by way of example and not limitation, pinch zoom manipulations, double tap zoom manipulations, as well as other manipulations without departing from the spirit and scope of the claimed subject matter.

In this example, three different threads are illustrated at 202, 204, and 206. An independent hit test thread 202 constitutes a thread that is utilized to conduct an independent hit test as described above and below. Manipulation thread 204 constitutes the thread that is configured to perform a manipulation for inputs that are received relative to independent regions associated with the displayed content. User interface thread 206 constitutes the main thread that is configured to perform various activities such as full hit testing on dependent regions associated with displayed content.

In one or more embodiments, independent hit testing can operate as follows. The independent hit test thread 202 is aware of regions on the displayed page which are independent and dependent. The manipulation thread 204 serves as or manages a delegate thread that is registered to receive messages associated with various types of inputs. The manipulation thread 204 receives input messages and updates before the user interface thread 206. The independent hit test thread 202 is registered with the manipulation thread 204 to receive input messages from the manipulation thread. When an input is received, the manipulation thread receives an associated message and sends a synchronous notification to the independent hit test thread 202. The independent hit test thread 202 receives the message and uses data contained therewithin to walk an associated display tree to perform a hit test. The entire display tree can be walked or a scoped traversal can take place, as described below. If the input occurs relative to an independent region, the independent hit test thread 202 calls manipulation thread 204 to inform the manipulation thread that it can initiate panning. In at least some embodiments, if the input occurs relative to a dependent region, then the manipulation thread 204 reassigns the input messages to the user interface thread 206 for processing by way of a full hit test. Reassigning the input messages to the user interface thread 206 carries with it efficiencies because the messages are kept in the same queue or location until reassignment occurs, thus keeping the message from being moved in the queue. Dependent regions that are not subject to manipulation based on an independent hit test include, by way of example and not limitation, those regions corresponding to elements including slider controls, video/audio playback and volume sliders, ActiveX controls, scrollbars, text selection grippers (and other adorners), and pages set to overflow.

In at least some embodiments, after an independent hit test is performed or during initiation of the manipulation, the input message that spawned the independent hit test is forwarded to the user interface thread 206 for normal processing. Normal processing is associated with basic interactions such as, by way of example and not limitation, processing that can apply various styles to elements that are the subject of the input. In these instances, forwarding the input message to the user interface thread does not block manipulation performed by the manipulation thread 204.

Returning to the FIG. 2 sequence diagram, a sequence of actions is shown each of which appears in an enumerated circle. The sequence is described in the context of a pan manipulation. It is to be appreciated and understood, however, that independent hit testing can be performed in conjunction with other manipulations such as zoom manipulations and the like. In addition, the input that is the subject of the sequence diagram is in the form of a touch input. As noted above, other types of inputs can be received and processed similarly without departing from the spirit and scope of the claimed subject matter.

At “1” a finger down event occurs responsive to a user touch-engaging an element that appears on a webpage which, in turn, spawns a pointer down input message. The pointer down input message is received by the manipulation thread 204 and placed in a queue. The pointer down input message is then sent by the manipulation thread 204 to the independent hit test thread 202. The independent hit test thread 202 receives, at “2”, the pointer down input message. This constitutes a departure from past practices in which the pointer down input message would be sent to the user interface thread 206 which, as described above, could result in delays due to other processing that the user interface thread 206 might be performing. Responsive to receiving the pointer down input message, the independent hit test thread 202 performs, at “3” an independent hit test by walking an associated display tree. If the independent hit test thread 202 ascertains that the region corresponding to the finger down event is an independent region, meaning that the user interface thread 206 is not needed for the manipulation to occur, the independent hit test thread 202 calls the manipulation thread to inform the manipulation thread that direct manipulation can occur. The manipulation thread, at “4” begins the manipulation which, in this example, is a panning manipulation. The independent hit test thread 202 can also, at “3”, call the user interface thread 206 so that the user interface thread can perform full hit testing at “5” to do such things as apply CSS styles and other DOM-related processing. If the independent hit test thread ascertains that the region corresponding to the finger down event is a dependent region, the independent hit test thread does not call the manipulation thread for direct manipulation. Instead, the input messages are reassigned by the manipulation thread to the user interface thread for processing. Assuming that the region is an independent region, the manipulation continues at “6”, under the influence of the manipulation thread 204, as the user's finger moves. The manipulation thread 204 ends the manipulation at “7” responsive to a finger up event.

Note that without the independent hit test thread 202, the pointer down input message would have been sent to the user interface thread 206 for processing and performing the full hit test before the manipulation could start. Because of other processing that the user interface thread 206 might be performing, the full hit test for purposes of manipulation might be delayed. As such, the manipulation would be initiated after conclusion of the full hit test, as indicated by the dashed arrow 208. This would result in a corresponding delay, indicated by the double-headed arrow, from the time between when manipulation is initiated under the influence of the independent hit test thread and the time when manipulation is initiated without the influence of the independent hit test thread. Accordingly, manipulation response times are improved and are consistently quick, regardless of the activity on the user interface thread 206.

Having considered an example system in accordance with one or more embodiments, consider now an example method in accordance with one or more embodiments.

### Example Method

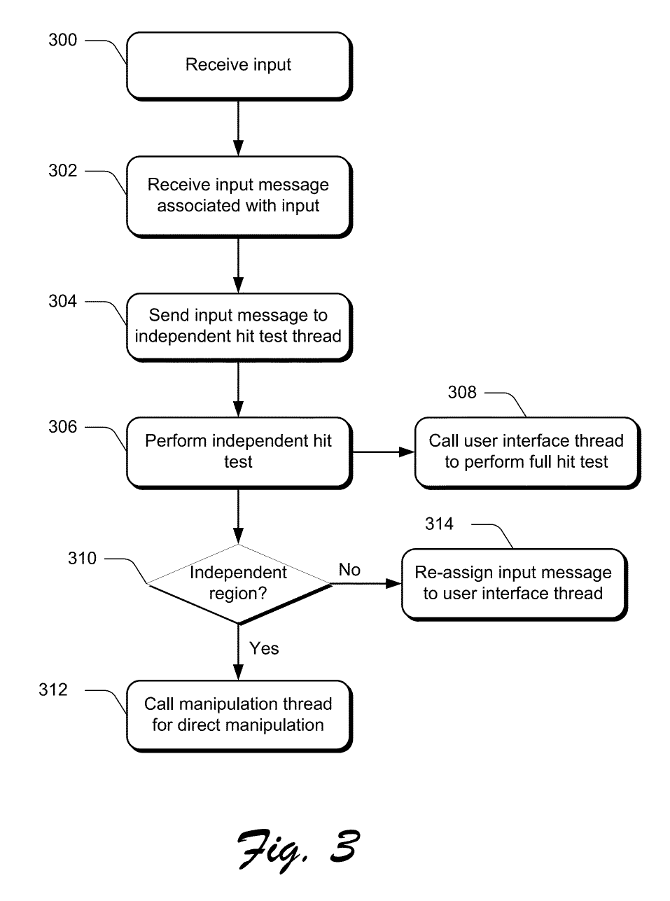

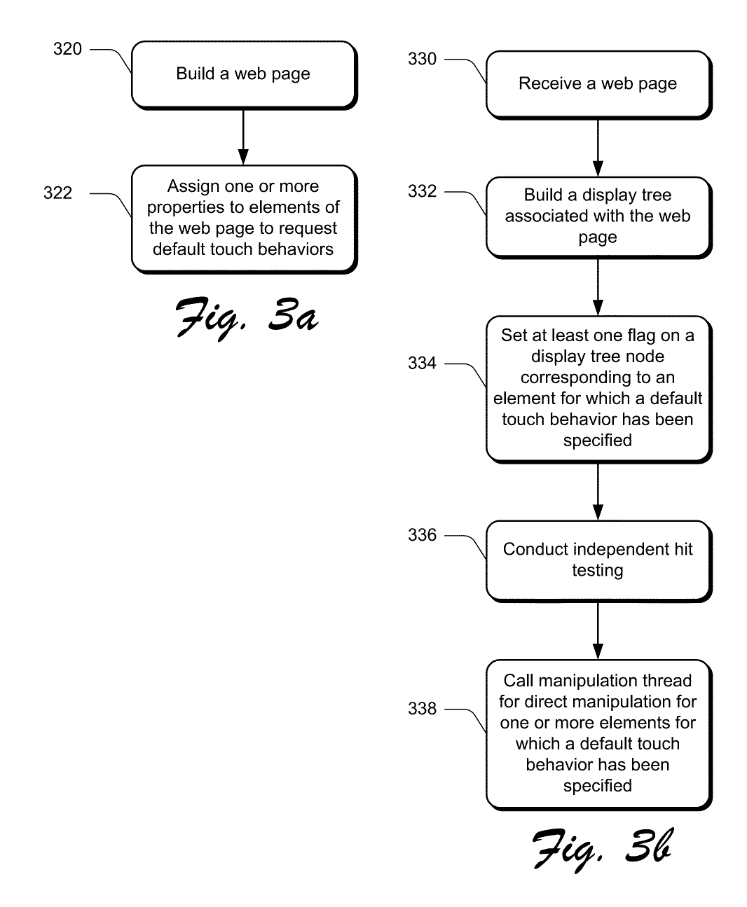

FIG. 3 is a flow diagram that describes steps in a method in accordance with one or more embodiments. The method can be implemented in connection with any suitable hardware, software, firmware, or combination thereof. In at least some embodiments, the method can be implemented by a suitably-configured system, such as one that includes an independent hit test thread.

Step 300 receives an input. Any suitable type of input can be received. In at least some embodiments, the input comprises a touch input. Other types of inputs can be received without departing from the spirit and scope of the claimed subject matter. Step 302 receives an input message associated with input. This step can be performed in any suitable way. In at least some embodiments, the input message is received by a manipulation thread and placed into a queue. Step 304 sends the input message to an independent hit test thread. Responsive to receiving the input message, the independent hit test thread performs an independent hit test. Step 308 calls a user interface thread to perform a full hit test. Examples of how and why this can be done are provided above. Step 310 ascertains whether a region associated with the input is an independent region. If the region is ascertained to be an independent region, then step 312 calls the manipulation thread for direct manipulation. An example of how this can be done is provided above. If, on the other hand, the region is ascertained to not be independent, i.e. dependent, then step 314 reassigns the input message to the user interface thread for processing.

Using a Scoped Tree Traversal for Independent Hit Testing

In one or more embodiments, a scoped tree traversal can be performed during the independent hit test. In these instances, the independent hit test need not conduct a full tree traversal to determine an appropriate response. Rather, portions of a corresponding display tree can be skipped when they are ascertained to be irrelevant with respect to the independent hit test.

In at least some embodiments, the elements of the display tree can be marked such that those elements are traversed during independent hit testing. Alternately, the elements of the display tree can be marked such that marked elements are not traversed during independent hit testing. In this manner, marking the display tree can determine whether or not elements are traversed during independent hit testing.

For example, there are characteristics and properties of elements in a display tree that do not lend themselves naturally to doing a hit test because of their function within the display tree. In those cases, these elements are marked so that they will not be hit tested. In a specific example, some elements in a display tree, because of their properties and characteristics, are processed by a display client. Such elements can include a range control. In these instances, the display node corresponding to the range control is a container with several nodes underneath it corresponding to the parts of the control. However, the range control itself does special processing of touch input on the user interface thread, so it implements a display client to do that processing and marks its display node as not-for-traversal. Thus, when the display node is encountered by the independent hit test thread, it skips traversal of the nodes underneath the range control.

Designating Specific Regions of a Display Tree Node for Independent Hit Testing

In at least some embodiments, specific regions of the display tree node can be designated for consideration during independent hit testing. This approach can be used in instances where a single display tree node has sub-regions of interest that may change a decision about the appropriate manipulation response. Example sub-regions include, by way of example and not limitation, a playback slider on a video element or a resize gripper on editable content.

Consider a display tree node in the form of a rectangle that has some content inside of it. An example of a display tree node may be one that includes video content. If the user touches the region corresponding to this display tree node, controls such as fast-forward, pause, volume, and the like may appear. Normally, it is desirable to process contacts on the particular video control in the normal, usual way such as by fast forwarding, pausing, or adjusting the volume of the video. Normally, when these controls are visible, these types of inputs are handled by the user interface thread. However, manipulations such as panning and zooming the display element corresponding to the video content can be done independently using independent hit testing. In this instance, the controls may be visible and the input that is received comprises a pinch or a pan input on the video which will result in the independent hit test thread processing the input message to affect the corresponding manipulation.

In one or more embodiments, a separate data structure is maintained as part of the display tree corresponding to these types of elements. The separate data structure maintains information for these types of display nodes. Depending on the input that is received, either the user interface thread will process the input messages in cases where, for example, input occurs on a video control, or the independent hit test thread and manipulation thread will process input with respect to these elements when panning or zooming occurs.

Registering a Callback Handler to be Executed as Part of the Response to an Independent Hit Test

Consider situations in which a user pans to the left or right with respect to content that is displayed by their web browser. Panning to the right is the equivalent of clicking the back button to navigate backwards in the browser. Accordingly, a user can flip back and forth through various pages. This enables a user to navigate backwards and forwards through a travel log associated with a navigation. In this instance, backward and forward navigation through content is handled by a different component than the independent hit test thread. In these instances, the component that handles backward and forward navigation can register for a callback as part of the response to an independent hit test.

Consider, for example, an I-frame and a corresponding webpage. Responsive to a panning manipulation, the I-frame pans first until it hits an edge, at which point the page starts to pan. Once the page hits its edge, then a backward navigation can be initiated. By registering a callback handler to be executed as part of the response to an independent hit test, the host can participate in this chain. For example, when a finger down input is received, a list of all of the scrollable regions up the display tree associated with that input is built. So, for example, if a user touches on a region that is ten scrollable areas deep, then the independent hit test thread can call the manipulation thread for each of those ten scrollable areas so that manipulation can occur. Using a callback handler as part of the response to the independent hit test can enable the component that processes backward and forward navigation to layer on top of those ten regions to effect backward and forward navigation as appropriate.

Declarative Style Rules for Default Behaviors

In at least some embodiments, a mechanism is provided for web developers to request specific default behaviors, such as touch behaviors, on their webpages. In at least some implementations, a Cascading Style Sheets rule is utilized to enable or disable manipulations such as panning, pinch zoom, and double-tap-zoom manipulations. The mechanism can be extensible to accommodate additional default behaviors that are added in the future. In various embodiments, the behaviors are declared up front and thus differ from solutions which employ an imperative model. The declarative nature of this approach allows achievement of full independence from the main thread and deciding the correct response using independent hit testing.

In one or more embodiments, the ability to control default actions, such as touch actions, is provided through the use of a new CSS property “touch-action”. The CSS property accepts values including, by way of example and not limitation, “auto”, “none”, and “inherit”. In addition, the CSS property is extensible insofar as enabling the use of a space delimited list of specific actions, such as touch actions, that may be utilized. By way of example and not limitation, this list includes the values “manipulation” and “double-tap-zoom” to control pan/pinch-zoom and double-tap-zoom, respectively. Additional capabilities can be added which can be enabled or disabled with this feature, thus adding extensibility to this property.

In one or more embodiments, the correct response after independent hit testing is that the first ancestor of the target which can handle a touch interaction does so. For manipulations, this may include regions which are actually manipulable, i.e. have been designated as scrollable or zoomable, as well as elements which choose to handle interaction via JavaScript, e.g. “touch-action: none”. This can also include certain elements which have their own manipulation response, e.g., sliders.

In operation, during independent hit testing which determines the particular element on the webpage that is under a user's finger, the corresponding display tree is traversed based, in part, on this CSS property. This enables scoping of the tree traversal in cases where no additional information is needed to determine the correct response.

Having considered an overview on declarative style rules for default behaviors, consider now a discussion of an implementation example that employs the techniques described above.

### Implementation Example

In the discussion below, the following terminology is used. A manipulable element is an element which either: (a) has overflow content and specifies overflow is to be automatically handled, (b) specifies that scrolling is allowed for overflow content, or (c) has zooming capabilities. A manipulation-blocking element is an element that explicitly blocks direct manipulation via declarative markup and, instead, will fire gesture events such as gesture start, gesture change, and gesture end events. A manipulation-causing element is an element which explicitly requests direct manipulation via declarative markup. A passive element is an element which does not fall into the three categories above. It does not contribute to the touch action decision.

With respect to the CSS property “touch action” consider the following. The “touch action” property includes the following values that can be set by web developers using declarative markup: auto, none, inherit, and <space-delimited gesture list>. The space-delimited gesture list can include “manipulation” and “double-tap-zoom”. The space-delimited gesture list is also extensible to support future added gestures.

The “auto” value defers a touch-action decision to the parent of a particular element, thus making the particular element a passive element. So, for example, if a touch input occurs on an element that itself cannot pan and has not blocked a pan manipulation, the touch-action decision is deferred up to the element's parent. This can continue scrolling up the chain of the element's ancestors until the touch-action decision is resolved, resulting either in a manipulation or no manipulation. This value can alleviate having to specify properties on every single element in a display tree chain.

The “none” value specifies that no panning or zooming is to occur on this element.

The “inherit” value specifies that the element inherits its property value from its parent, per standard CSS inheritance.

The “manipulation” value specifies that the associated element is to be treated as a manipulation-causing element, i.e., an element which explicitly requests direct manipulation. Accordingly, this element will pan and/or zoom and no gesture events will fire.

The “double-tap-zoom” value specifies that the associated element is to be treated as a manipulation-blocking element meaning that the element explicitly blocks direct manipulation and will instead cause gesture events to be fired. In this instance, if only “double-tap-zoom” is specified for an element, the element will not pan or pinch zoom. Note that if “manipulation” is specified for an element but “double-tap-zoom” is not specified, the element can only be panned and pinch zoomed.

In operation, manipulations are assigned to the first manipulable or manipulation-blocking element in the target element's parent chain. In the event that the element is both manipulable and manipulation-blocking, direct manipulation does not occur meaning that manipulation-blocking occurs. If there is no manipulable or manipulation-blocking element in the target element's parent chain, manipulation events are sent or fired.

Consider now how the above values are processed during independent hit testing. When the display tree is initially built for a particular page, if the above-described property values are encountered, a flag is pushed onto each display tree node that corresponds to a particular element for which a property value specified. Thus, each display tree node carries with it its state as defined by the above-described property values.

During independent hit testing, the display tree is walked and these flags are accumulated to ascertain whether the independent hit test thread should call the manipulation thread for direct manipulation. These flags are essentially built up in a manner described above and then assigned to a viewport which ultimately decides how the page or content will pan, zoom, or be manipulated. Thus, manipulations can be configured on-the-fly based on hit test results. Once the independent hit test is completed and the configuration is ascertained, the independent hit test thread can make the appropriate calls to the manipulation thread for direct manipulation.

FIG. 3a is a flow diagram that describes steps in a method in accordance with one or more embodiments. The method can be implemented in connection with any suitable hardware, software, firmware, or combination thereof. In at least some embodiments, the method can be implemented by a suitably-configured web page development system that includes software enabling a developer to develop a web page.

Step 320 builds a webpage. This step can be performed in any suitable way using any suitably-configured webpage development software package. Step 322 assigns one or more properties to elements of the webpage to request one or more respective default touch behaviors. Examples of how this can be done are provided above.

FIG. 3b is a flow diagram that describes steps in a method in accordance with one or more embodiments. The method can be implemented in connection with any suitable hardware, software, firmware, or combination thereof. In at least some embodiments, the method can be implemented by a suitably-configured system such as one that includes, among other components, an independent hit test component such as that described above.

Step 330 receives a webpage. Step 332 builds a display tree associated with the webpage. Step 334 sets at least one flag on a display tree node corresponding to an element for which a default touch behavior has been specified. Examples of how this can be done are provided above. Step 336 conducts an independent hit test on the display tree. Examples of how this can be done are provided above. Step 338 calls a manipulation thread for direct manipulation for one or more elements for which a default touch behavior has been specified. Examples of how this can be done are provided above.

Having considered an example implementation, consider now a discussion of alternate embodiments for identifying and handling various input gestures.

Touchpad and Double-Tap Zoom Considerations

Using the above described techniques, an independent hit thread can be configured to, among other things, identify independent and dependent regions contained within content, and further enable parallel processing of actions related to these regions. For instance, an independent hit thread can be configured to identify an independent region and hand-off associated processing to a manipulation thread. Alternately or additionally, the independent hit thread can identify dependent regions and hand-off processing to a thread that manages associated dependencies, such as a user interface thread. By dispersing processing to different threads, manipulations that were previously delayed due to execution bottlenecks can be processed in a more timely fashion, resulting in a more responsive user interface than in the bottleneck architecture. At times, however, a delay can be incurred when identifying multiple-gesture inputs.

For example, consider a double-tap zoom. As indicated by its name, some embodiments invoke zoom functionality responsive to identifying a double-tap input, whether the double-tap input is associated with double mouse clicks, a double-tap input associated with a touch-screen, a double-tap on a touchpad, and so forth. Once the two taps in the sequence are identified, zooming functionality can be invoked. However, until the second tap of the multiple-gesture is identified, there can be uncertainty associated with the first tap, and whether to interpret it as an independent input (e.g. a single tap selection input), or as part of a multiple-gesture input (e.g. the double-tap zoom). This uncertainty in identifying the first tap can, in turn, cause delay in responsiveness until the first tap's associated role (e.g. independent input or multiple-gesture input) is identified. For example, if a tap input is associated with a single and/or independent input, any delay in waiting for a potential second tap and/or timeout can impact a user's perception during that waiting period.

Some embodiments provide an independent hit test thread that is configured to identify one or more input scenarios associated with an input, such as an interpretation of the input as a single and/or independent input, an interpretation of the input as a multiple-gesture input, and so forth. In some cases, each input scenario has an associated response action that can be at least partially initiated and/or passed to a separate thread for initialization. A partially initialized response action can include, by way of example and not limitation, object and/or display manipulations, as further described above. A complete response action can be invoked when the input has been identified as a distinct input with a distinct response action from the one or more response actions, as further described above and below.

Consider FIG. 4, which illustrates an example sequence diagram, generally at 400, associated with a double-tap zoom. Here, a user executes a multi-gesture input in the form of two separate “finger down-finger up” gestures detected via a touch screen. However, it is to be appreciated that any suitable type of input can be provided for the “finger down-finger up” gesture, examples of which are provided above and below. Further, while described in the context of a double-tap zoom and its associated multiple-gesture input of a double-tap, it is to be appreciated that techniques described herein are applicable any multiple-gesture input without departing from the scope of the claimed subject matter.

Here, the sequence diagram described generally at 400 includes independent hit test thread 202, manipulation thread 204, and user interface thread 206 as discussed above with reference to FIG. 2. At “1”, a finger down-finger up event occurs responsive to detection of a user tap on element that appears on a web page which, in turn, spawns a tap input message. This is received by manipulation thread 204 and placed in a queue. The tap input message is then sent to independent hit test thread 202, which is received at “2”. While described in the context of receiving notification of a tap input event, it is to be appreciated that any other suitable type of event could be identified as well. For instance, instead of identifying a tap event that comprises the multiple-input events of a finger down and a finger up, some embodiments separately identify the finger down event and finger up events, and send separate input messages, such as a pointer down event message and a pointer up event message.

Upon receiving the tap input message at “2”, independent hit test thread begins one or more actions at “3”, such as a display tree traversal as described above and/or multiple-gesture input analysis. In this example, independent hit test thread 202 contains logic and/or knowledge that is aware that a tap event can be interpreted in multiple ways, such being a single tap input or part of a multiple-gesture input. Thus, independent hit test thread 202 sends a message and/or calls to user interface thread 206 as notification of the single tap input, indicated here at “4”. Alternately or additionally, user interface thread 206 can receive an event notification. In some embodiments, the notification to user interface thread 206 can include information indicating that the single tap input has not been distinctly identified, and that it can potentially be interpreted in multiple ways. In other words, the single tap input is identified as a potential interpretation of input, but not a final and/or distinct interpretation. This can be achieved in any suitable manner, such as through including information within a message received by user interface thread 206, through parameter(s) passed in during a call to user interface thread 206, storing information within a shared data structure between independent hit test thread 202 and user interface thread 206, and so forth. Responsive to identifying the single tap input as a potential interpretation, user interface thread 206 performs a partial initialization of an associated response action.

At “4”, user interface thread 206 performs a partial initialization. This can include any suitable type of action, examples of which are provided above. For instance, referring to the above discussion of CSS rules, a partial initialization can include processing one or more CSS rules associated with one or more elements effective to alter an appearance of one or more elements displayed via user interface thread 206. Alternately or additionally, user interface thread 206 can run associated scripts, such as JavaScript. Thus, user interface thread 206 begins processing, at least in part, a response action associated with receiving a single tap input.

At “5”, manipulation thread 204 receives notification of a second tap event. As in the case above, manipulation thread 204 then passes a message and/or notification to independent hit test thread 202. At “6”, independent hit test thread 202 receives the notification of the second tap event. At “7”, independent hit test thread 202 identifies the combination of first tap event and the second tap event as a multiple-gesture input (e.g. a double-tap). Identifying a multiple-gesture input can be achieved in any suitable manner. For example, a timer can be started upon receipt of the first tap event notification effective to determine whether a second tap event occurs within a pre-defined window of time. Alternately or additionally, each tap event can be time-stamped and a measure of time between the first and second tap events can be calculated and compared to a threshold. Thus, independent hit test thread 202 identifies the combination of the first and second tap events as a multiple-gesture input (e.g. double-tap) out of multiple potential interpretations of the inputs (e.g. single click, double-tap, tap and hold, etc.) that could be associated with the first tap event.

Upon distinctly identifying an interpretation of the first and second tap events (e.g. distinctly identifying as a double-tap input), independent hit test thread 202 then analyzes what other interpretation response actions may have been partially initialized. For instance, at “3”, a single tap input response action has been at least partially initialized in user interface thread 206. Independent hit test thread 202 then sends a notification to threads that have partially initialized response actions. Alternately or additionally, independent hit test thread 202 can terminate any partially initialized response actions managed within its own thread. In this example, independent hit test thread 206 sends user interface thread 206 a message to terminate and/or stop processing the single tap input response action. This is illustrated at “8”, where user interface thread 206 receives a cancel notification. It is to be appreciated that any suitable type of notification can be used without departing from the scope of the claimed subject matter. For example, returning to the above example of a shared data structure, in some embodiments, user interface thread 206 can access the shared data structure for notifications and/or identifications of a termination request. In response to receiving a notification at “8”, user interface thread 206 terminates and/or reverses any previous action executed at “4”.

At “9”, independent hit test thread 202 sends a notification of the multiple-gesture input to manipulation thread 204. Here, the notification is sent to manipulation thread 204 in response to independent hit test thread 202 determining that any associated elements and/or actions can be managed and/or processed by manipulation thread 204, as discussed above. At “10”, manipulation thread 204 receives the notification in any suitable manner, examples of which are described above. While FIG. 4 illustrates independent hit test thread 202 as first sending user interface thread 206 a notification to cancel the previous response action (e.g. single tap input response action), and then sending manipulation thread 204 a notification of the multi-gesture input, it is to be appreciated and understood that these sequence of events can occur in any order without departing from the scope of the claimed subject matter. At “11”, manipulation thread processes and/or executes an associated response action to the multiple-gesture input (e.g. a double-tap zoom).

For simplicity's sake, FIG. 4 illustrates a sequence diagram that describes a timeline related to determining a multiple-gesture input, and staggering multiple potential responses. For example, when a first tap is detected at “1”, a partial response action related to the first tap being a single-gesture input is initialized (indicated here at “3” and at “4”). It is not until a second tap is detected at “5” that the multiple-gesture input is recognized as a multiple-gesture input. At this point, the multiple-gesture input response action is initialized and the single-gesture input is terminated at “7” and at “8”. However, in some embodiments, the partial response can be fully initialized at a later point in time, such as upon determining a multiple-gesture input never occurs. Determining the absence of a multiple-gesture input can be achieved in any suitable manner, such as through the use of a timeout timer. In terms of FIG. 4, if the event at “5” does not occur within a pre-determined time threshold, the multiple-gesture input is not recognized. In turn, this can trigger a message to complete any partially initialized response action associated with the single-gesture input. Alternately or additionally, the single-gesture response action initiated at “3” could be a full initialization (instead of a partial initialization) that runs to completion due to the absence of the event at “5” (and subsequently the termination message at “7” and at “8”).

As another example, consider FIG. 5, which illustrates a sequence diagram, generally at 500, associated with a double-tap zoom. As in the case of FIG. 4, FIG. 5 is associated with a user performing a multiple-gesture input in the form of two separate “finger down-finger up” gestures. Further, FIG. 5 includes independent hit test thread 202, manipulation thread 204, and user interface thread 206 as discussed above with reference to FIGS. 2 and 4. At “1”, a “finger down-finger up” event occurs responsive to a user touch engaging an element that appears on a web page which, in turn, spawns a tap input message. This is received by manipulation thread 204 and placed in a queue. The tap input message is then sent to independent hit test thread 202, which is received by independent hit test thread 202 at “2” in a similar manner to that described above. Here, however, timing differences in when events are received in FIG. 5 invoke slightly different behavior.

Prior to independent hit test thread 202 processing the first tap input message, and sending a notification to user interface thread 206 to perform a partial initialization, a second tap input message is received by manipulation thread 204 at “3”. In turn, manipulation thread 204 sends a notification to independent hit test thread 202, which is received at “4”. Because user interface thread 206 has not yet received the partial initialization message from independent hit test thread 202, independent hit test thread 202 bypasses sending any partial initialization messages user interface thread 206 for this sequence of events. Instead, at “5”, independent hit test thread 202 identifies the two tap input messages as being a multiple-gesture input associated with double tap-zoom functionality. In turn, a notification of the double-tap zoom and/or the multiple-gesture input is sent by independent hit test thread 202 and received by manipulation thread 204 at “6”. At “7”, manipulation thread 204 performs a double-tap zoom, as previously discussed.

Thus, an independent hit test thread can not only determine whether a manipulation and/or associated content is independent or dependent (and manage which threads process functionality associated with the content), but it can also include functionality and/or logic to discern between single-input gestures and multiple-input gestures. In some cases, the additional logic can include algorithms, such as input pointer delay and/or zooming algorithms described in U.S. patent application Ser. No. 13/363,127. These algorithms can be used to identify parameters and/or options that are then communicated to a manipulation thread. For instance, the algorithms can be used to determine zoom ratios that are based upon what content is being zoomed in on. In turn, these zoom ratios can be passed to the manipulation thread as part of the zooming process.

At times, it can be beneficial to enable and disable independent hit test functionality. For instance, consider a touchpad. In some embodiments, when a user interacts with the touchpad, the input can be interpreted in a manner similar to that of a mouse peripheral device. When in this “mouse mode”, a user touches the touchpad interface and can “click” on elements through a tap, move a displayed mouse pointer by maintaining the touch contact to the interface and sliding in a desired direction, and so forth. However, in some scenarios, it can be desirable to enable hit testing. Consider the above discussions related to panning functionality. At times, when processing panning functionality, it can be beneficial to perform hit testing to determine an appropriate manipulation target. Some embodiments provide an ability to transition into (and out of) a “gesture mode”. For example, in some cases, detecting a multiple-gesture input enables a “gesture mode”, such as detecting multiple simultaneous finger interactions on the touchpad. When transitioning into a “gesture mode”, inputs can be processed and/or analyzed using independent hit test thread techniques similar to those described above. Alternately or additionally, new rules can be applied and/or inputs can be interpreted differently than when in “mouse mode”. For instance, when in “mouse mode”, detecting input associated with a finger moving across a touchpad can invoke a response action that causes a mouse icon to move in a related direction as the finger movements. However, detecting a similar input when in “gesture mode” can instead invoke a response action that causes an associated display to pan left or right. Any suitable type of event and or input can cause a transition into (and out of) “gesture mode”, such as detecting a first input associated with a “touch-and-hold” gesture in conjunction with a second input associated with a “swipe” gesture, detecting a lack of gestures (e.g. detecting the absence of the “touch-and-hold” gesture and/or the “swipe” gesture), and so forth. Some embodiments transition back into “mouse mode” upon detecting a mouse mode input event, such as an end to the multiple-gesture input associated with “gesture mode”, detection of a distinct input associated with transition into “mouse mode”, and so forth.

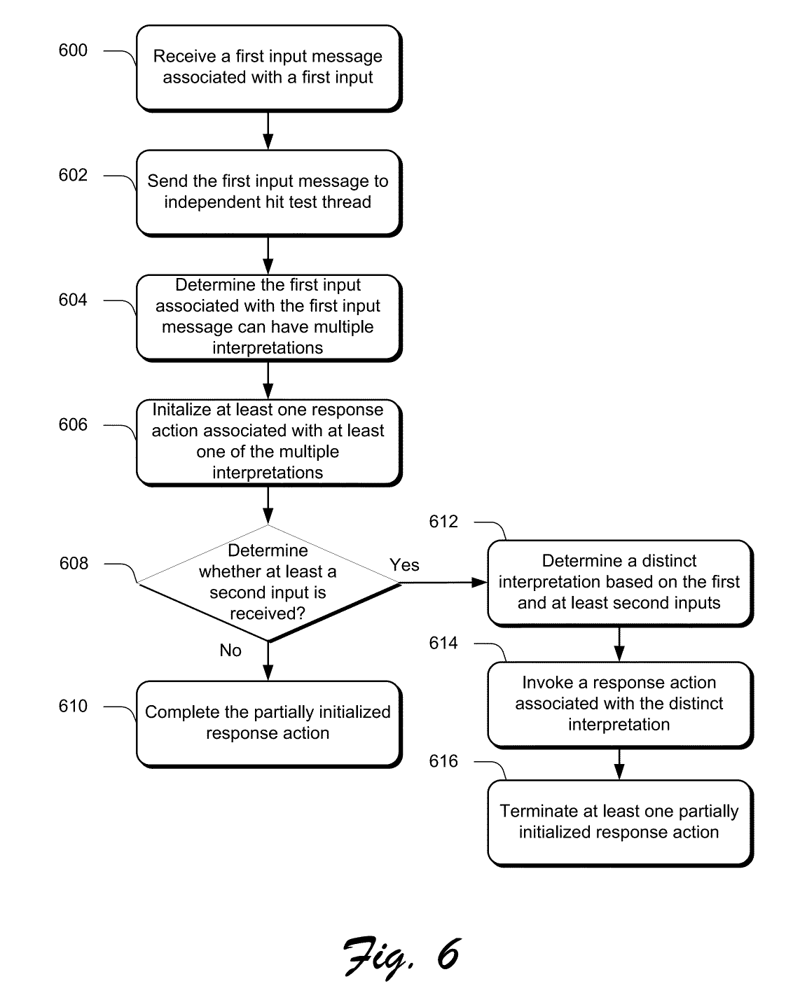

FIG. 6 is a flow diagram that describes steps in a method in accordance with one or more embodiments. The method can be implemented in connection with any suitable hardware, software, firmware, or combination thereof. In at least some embodiments, the method can be implemented by a suitably-configured system such as one that includes, among other components, an independent hit test component such as that described above.

Step 600 receives a first input message associated with a first input. This can include any suitable type of input message and/or input, such as input from a touch screen, touchpad, mouse device, a keyboard input, and so forth. In some cases, the first input message is received on a thread that is separate from a user interface thread and/or an independent hit test thread. Step 602 sends the first input message to an independent hit test thread.

Responsive to receiving the first input message, step 604 determines the first input associated with the first input message has multiple interpretations. For example, the first input can be interpreted as a single-gesture input, or interpreted as part of one or more multiple-gesture inputs. Alternately or additionally, responsive to receiving the first input message, the independent hit test thread can perform at least some hit testing, example of which are provided above.

Step 606 initializes at least one response action associated with at least one of the multiple interpretations. This can include a full initialization and/or a partial initialization of the associated response action. In some cases, the independent hit test thread sends a notification to a separate thread to perform the initialization, where the notification can include an indicator of whether the initialization should be a full or partial initialization. Alternately or additionally, the separate thread can utilize a shared data structure to determine what type of initialization to perform. An initialization can include any suitable type of action, such as applying one or more CSS rules to an element, allocating data structures, and so forth.

Step 608 determines whether at least a second input is received. In some cases, this can include determining whether the second input is received within a predefined window of time. For example, a second input message associated with a second input can be received in a similar manner as the first input message. If the second input message is not received within the predefined window of time, some embodiments determine the second input message is not associated with the first input message, and then process and/or respond to the second input message independently from the first input message. However, if the second input message is received within the predefined window of time, the inputs are analyzed further to determine whether the first and second inputs are part of a multiple-gesture input.

Responsive to determining a second input is not received, step 610 completes the partially initialized response action. In some cases, a message to complete the response action is sent to the thread assigned to processing the partially initialized response. In other cases, completing the partially initialized response action is accomplished by simply letting the initialization performed in step 606 to complete uninterrupted.

Responsive to determining a second input has been received, step 612 determines a distinct interpretation of the first input based on the first and second inputs. For instance, if the first input had four possible interpretations, step 612 selects one of the four interpretations based upon what the inputs had received, and potentially when. Referring to the above example of a double-tap gesture, the first tap input would be determined as a distinct double-tap input based upon whether a second tap input is received, and whether the second tap input is received predefined time window. Thus, determining a distinct interpretation of an input can be based not only upon what inputs have been received, but additionally based upon whether the inputs have been received within a predefined time window, based upon an order they are received in, a duration of the input, and so forth.

Responsive to determining a distinct interpretation associated with an input, step 614 invokes a response action associated with the distinct interpretation. Any suitable type of response action can be invoked, examples of which are provided above. In some cases, invoking a response action can include notifying a separate thread effective to enable the separate thread to process the response action. Alternately or additionally, a response action can be based, at least in part, on what state or mode a device is running in, such as the “gesture mode” and “mouse mode” examples described above.

Step 616 terminates at least one partially initialized response action. In some embodiments, a notification and/or message is sent to a thread that processed the partially initialized response action. In other embodiments, a shared data structure is updated with a notice to terminate the partially response action.

Having considered various embodiments, consider now an example system and device they can be utilized to implement the embodiments described above.

### Example System and Device

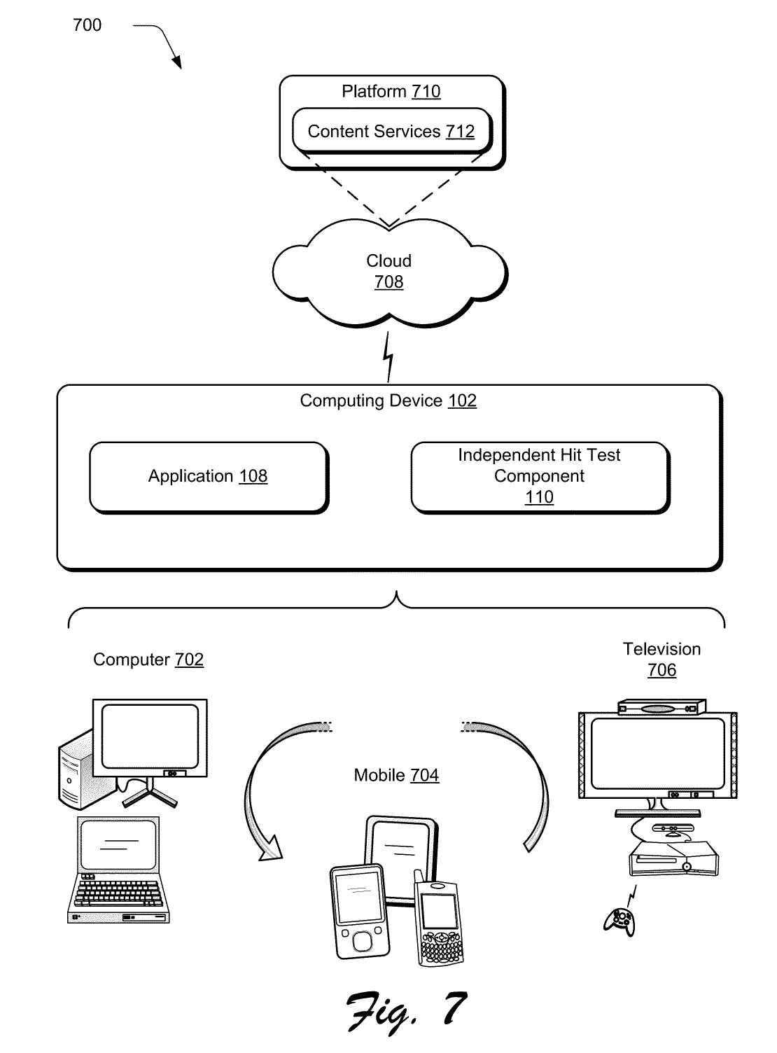

FIG. 7 illustrates an example system 700 that includes the computing device 102 as described with reference to FIG. 1. The example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 702, mobile 704, and television 706 uses. Each of these configurations includes devices that may have generally different constructs and capabilities, and thus the computing device 102 may be configured according to one or more of the different device classes. For instance, the computing device 102 may be implemented as the computer 702 class of a device that includes a personal computer, desktop computer, a multi-screen computer, laptop computer, netbook, and so on. Each of these different configurations may employ the techniques described herein, as illustrated through inclusion of the application 108 and independent hit test component 110.

The computing device 102 may also be implemented as the mobile 704 class of device that includes mobile devices, such as a mobile phone, portable music player, portable gaming device, a tablet computer, a multi-screen computer, and so on. The computing device 102 may also be implemented as the television 706 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein.

The cloud 708 includes and/or is representative of a platform 710 for content services 712. The platform 710 abstracts underlying functionality of hardware (e.g., servers) and software resources of the cloud 708. The content services 712 may include applications and/or data that can be utilized while computer processing is executed on servers that are remote from the computing device 102. Content services 712 can be provided as a service over the Internet and/or through a subscriber network, such as a cellular or Wi-Fi network.

The platform 710 may abstract resources and functions to connect the computing device 102 with other computing devices. The platform 710 may also serve to abstract scaling of resources to provide a corresponding level of scale to encountered demand for the content services 712 that are implemented via the platform 710. Accordingly, in an interconnected device embodiment, implementation of functionality described herein may be distributed throughout the system 700. For example, the functionality may be implemented in part on the computing device 102 as well as via the platform 710 that abstracts the functionality of the cloud 708.

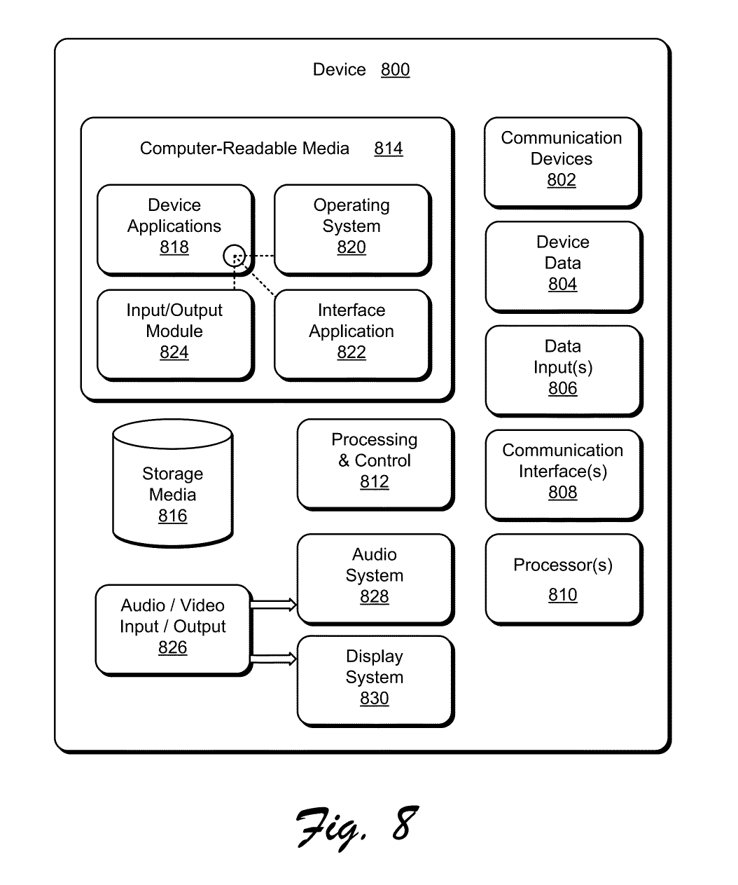

FIG. 8 illustrates various components of an example device 800 that can be implemented as any type of computing device as described with reference to FIGS. 1 and 7 to implement embodiments of the techniques described herein. Device 800 includes communication devices 802 that enable wired and/or wireless communication of device data 804 (e.g., received data, data that is being received, data scheduled for broadcast, data packets of the data, etc.). The device data 804 or other device content can include configuration settings of the device, media content stored on the device, and/or information associated with a user of the device. Media content stored on device 800 can include any type of audio, video, and/or image data. Device 800 includes one or more data inputs 806 via which any type of data, media content, and/or inputs can be received, such as user-selectable inputs, messages, music, television media content, recorded video content, and any other type of audio, video, and/or image data received from any content and/or data source.

Device 800 also includes communication interfaces 808 that can be implemented as any one or more of a serial and/or parallel interface, a wireless interface, any type of network interface, a modem, and as any other type of communication interface. The communication interfaces 808 provide a connection and/or communication links between device 800 and a communication network by which other electronic, computing, and communication devices communicate data with device 800.

Device 800 includes one or more processors 810 (e.g., any of microprocessors, controllers, and the like) which process various computer-executable instructions to control the operation of device 800 and to implement embodiments of the techniques described herein. Alternatively or in addition, device 800 can be implemented with any one or combination of hardware, firmware, or fixed logic circuitry that is implemented in connection with processing and control circuits which are generally identified at 812. Although not shown, device 800 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 800 also includes computer-readable media 814, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 800 can also include a mass storage media device 816.

Computer-readable media 814 provides data storage mechanisms to store the device data 804, as well as various device applications 818 and any other types of information and/or data related to operational aspects of device 800. For example, an operating system 820 can be maintained as a computer application with the computer-readable media 814 and executed on processors 810. The device applications 818 can include a device manager (e.g., a control application, software application, signal processing and control module, code that is native to a particular device, a hardware abstraction layer for a particular device, etc.). The device applications 818 also include any system components or modules to implement embodiments of the techniques described herein. In this example, the device applications 818 include an interface application 822 and an input/output module 824 that are shown as software modules and/or computer applications. The input/output module 824 is representative of software that is used to provide an interface with a device configured to capture inputs, such as a touchscreen, track pad, camera, microphone, and so on. Alternatively or in addition, the interface application 822 and the input/output module 824 can be implemented as hardware, software, firmware, or any combination thereof. Additionally, the input/output module 824 may be configured to support multiple input devices, such as separate devices to capture visual and audio inputs, respectively.

Device 800 also includes an audio and/or video input-output system 826 that provides audio data to an audio system 828 and/or provides video data to a display system 830. The audio system 828 and/or the display system 830 can include any devices that process, display, and/or otherwise render audio, video, and image data. Video signals and audio signals can be communicated from device 800 to an audio device and/or to a display device via an RF (radio frequency) link, S-video link, composite video link, component video link, DVI (digital video interface), analog audio connection, or other similar communication link. In an embodiment, the audio system 828 and/or the display system 830 are implemented as external components to device 800. Alternatively, the audio system 828 and/or the display system 830 are implemented as integrated components of example device 800.

### CONCLUSION

In one or more embodiments, a hit test thread which is separate from the main thread, e.g. the user interface thread, is utilized for hit testing on web content. Using a separate thread for hit testing can allow targets to be quickly ascertained. In cases where the appropriate response is handled by a separate thread, such as a manipulation thread that can be used for touch manipulations such as panning and pinch zooming, manipulation can occur without blocking on the main thread. This results in the response time that is consistently quick even on low-end hardware over a variety of scenarios.

In at least some embodiments, a mechanism is provided for web developers to request specific default behaviors, such as touch behaviors, on their webpages. In at least some implementations, a Cascading Style Sheets (CSS) rule is utilized to enable or disable manipulations such as panning, pinch zoom, and double-tap-zoom manipulations. The mechanism can be extensible to accommodate additional default behaviors that are added in the future. In various embodiments, the behaviors are declared up front and thus differ from solutions which employ an imperative model. The declarative nature of this approach allows achievement of full independence from the main thread and deciding the correct response using independent hit testing.

Some embodiments provide an ability to perform additional processing and/or logic handling within an independent hit test thread. In some cases, the independent hit test thread can be configured to identify between one or more input scenarios. Alternately or additionally, one or more response actions to the input scenarios can be at least partially initialized. Upon determining a distinct input scenario from the one or more input scenarios, an associated response action can be initiated and/or passed to a separate thread for execution. At times, a notification to terminate a response action can be sent to threads managing the at least partially initialized response actions.

Although the embodiments have been described in language specific to structural features and/or methodological acts, it is to be understood that the various embodiments defined in the appended claims are not necessarily limited to the specific features or acts described. Rather, the specific features and acts are disclosed as example forms of implementing the various embodiments.

What is claimed is:

1. A computer-implemented method comprising:
receiving, on an independent hit test thread, a first input message associated with a first input;
determining, using the independent hit test thread, the first input associated with the first input message has multiple interpretations;
initializing, using the independent hit test thread, at least one response action associated with at least one interpretation of the multiple interpretations;
determining, using the independent hit test thread, whether a second input is received;
responsive to determining the second input is received, determining, using the independent hit test thread, a distinct interpretation of the first input from the multiple interpretations based, at least in part, on the first input and second input; and
invoking, using the independent hit test thread, a response action associated with the distinct interpretation.

2. The computer-implemented method of claim 1 further comprising:
terminating, using the independent hit test thread, the at least one response action.

3. The computer-implemented method of claim 1, wherein initializing the at least one response action further comprises a partial initialization of the at least one response action.

4. The computer-implemented method of claim 3 further comprising completing the partial initialization of the at least one response action.

5. The computer-implemented method of claim 4 wherein completing the partial initialization of the at least one response action is responsive to determining the second input is received outside of a predefined window of time.

6. The computer-implemented method of claim 3, wherein the partial initialization comprises applying one or more Cascading Style Sheet (CSS) rules to one or more elements associated with the first input.

7. The computer-implemented method of claim 1 further comprising:
determining, using the independent hit test thread, a zoom ratio associated with the first input.

8. One or more computer-readable storage memories comprising processor-executable instructions which, responsive to execution by at least one processor, are configured to:
receive a first input message associated with a first input;
determine the first input associated with the first input message has multiple interpretations;
partially initialize at least one response action associated with at least one interpretation of the multiple interpretations;
determine whether at least a second input is received within a predefined window of time;
responsive to determining the at least second input is not received within the predefined window of time, complete one of said partially initialized at least one response action; and
responsive to determining the at least second input is received within the predefined window of time, invoke a response action associated with a distinct interpretation of the first input based, at least in part, on the first input and the at least second input.

9. The computer-readable storage memories of claim 8, wherein the first input and the at least second input are associated with input received via a touchpad.

10. The computer-readable storage memories of claim 9, wherein the processor-executable instructions are further configured to:
identify a multiple-gesture input associated with input received via the touchpad;
responsive to identifying the multiple-gesture input, transition into a gesture mode, the gesture mode configured to enable independent hit testing, using an independent hit test thread, of input received via the touchpad; and
responsive to identifying a mouse mode input event, transition from the gesture mode into a mouse mode, wherein the mouse mode and the gesture mode interpret input received via the touchpad differently.

11. The computer-readable storage memories of claim 10, wherein the mouse mode input event comprises an end to the multiple-gesture input.

12. The computer-readable storage memories of claim 8, wherein the processor-executable instructions are further configured to:
determine the first input has multiple interpretations using an independent hit test thread; and
partially initialize the at least one response action using a user interface thread.

13. The computer-readable storage memories of claim 12, wherein the processor-executable instructions are further configured to invoke the response action associated with the distinct interpretation on a manipulation thread.

14. The computer-readable storage memories of claim 12, wherein the processor-executable instructions to partially initialize the at least one response action using a user interface thread are further configured to communicate instructions to partially initialize the at least one response action to the user interface using a shared data structure between the independent hit test thread and the user interface thread.

15. The computer-readable storage memories of claim 8, wherein the processor-executable instructions are further configured to terminate the partially initialized at least one response action in response to determining the distinct interpretation of the first input.

16. One or more computer-readable storage memories comprising processor-executable instructions which, responsive to execution by at least one processor, are configured to implement:
an independent hit test component, the independent hit test component configured to:
receive a first input message associated with a first input;
determine the first input is associated with a single-gesture interpretation and a multiple-gesture interpretation;
partially initialize a response action associated with the single-gesture interpretation;
identify the multiple-gesture input based, at least in part, on receiving a second input message associated with a second input;
terminate the response action associated with the single-gesture interpretation; and
invoke a response action associated with the multiple-gesture interpretation.

17. The one or more computer-readable storage memories of claim 16, wherein the independent hit test component is further configured to:
receive the first input message on an independent hit test thread;
partially initialize a response action associated with the single-gesture interpretation on a second thread; and
invoke the response action associated with the multiple-gesture interpretation on the second thread or a third thread.

18. The one or more computer-readable storage memories of claim 17, wherein the distinct interpretation of the first input comprises a double-tap zoom interpretation.

19. The one or more computer-readable storage memories of claim 17, wherein the independent hit test component is further configured to:
identify a first input effective to transition into a gesture mode; and
identify a second input effective to transition into a mouse mode,
wherein the gesture mode and mouse mode interpret a same input differently.

20. The one or more computer-readable storage memories of claim 17, wherein the independent hit test component is further configured to:
compute a zoom ratio using the independent hit test thread; and
communicate the zoom ratio to the second thread or the third thread, wherein the second thread is a user interface thread and the third thread is a manipulation thread.
